(19) United States
(12) Patent Application Publication
(10) Pub. No.: US 2005/0255805 A1
(43) Pub. Date: Nov. 17, 2005

(54) Data transmission method and system

(76) Inventor: Ari Hottinen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/515,939

(22) PCT Filed: May 28, 2003
(86) PCT No.: PCT/FI03/00420

§ 371 Date: Nov. 24, 2004

(30) Foreign Application Priority Data
May 29, 2002 (FI) 20021013

(51) Int. Cl. H04B 7/14

(52) U.S. Cl. 455/8

(57) ABSTRACT

A data transmission system and a data transmission method between two transceivers are provided. At least one of the transceivers employs more than one radiation patterns for transmitting and receiving a signal. The symbols to be transmitted are divided into blocks, which are encoded using a first space-time coding and one block is transmitted from each radiation pattern. The receiver checks whether retransmission is required and then transmits a retransmission message to the transmitter and stores at least some of the blocks in a memory. The transmitter encodes at least some of the same blocks using a second space-time coding and retransmits the blocks. The receiver receives the blocks using one or more antennas and performs a combined detection or decoding with the blocks in the memory.

### FIELD OF THE INVENTION

The invention relates to data transmission between two transceivers. In particular, the invention relates to a solution, in which more than one antenna is used for transmitting and receiving signals in at least one of the transceivers.

### BACKGROUND OF THE INVENTION

At present, telephone systems are not only used for transmitting conventional calls but also for offering a number of other services. New service concepts are continuously created. Various services have been designed for radio telephone systems in particular. These services are favoured by users, since most of them always carry a mobile phone and thus the services are available at all times.

Different services require different transmission capacities from the radio connection. A significant research project in the field of wireless telecommunication systems is how to increase the data transmission capacity over a radio connection. Various methods have been proposed to improve the capacity of existing radio systems and new systems as much as possible. However, each method has its own advantages and disadvantages.

An obvious alternative to increase the data rate is to use a higher order modulation method. A disadvantage of such methods is, however, that in order to function properly they require a good signal-to-noise ratio. Secondly, particularly in TDMA systems, the structure of the equalizer required in the system becomes complex. The radio frequency parts of base stations and terminals typically generate non-linearity in a signal. Since interference is also generated in the signal, it is difficult to achieve an adequately good signal-to-noise ratio.

Another alternative is to use diversity in signal transmission. Diversity allows improving the signal-to-noise ratio of a signal received in a receiver, and thus to increase the average data rate. A prior art transmission diversity method is delay diversity where the signal is transmitted twice, the latter transmission being delayed. However, this solution is clearly suboptimal.

A better method for achieving diversity is to employ space-time block coding (STBC), which provides the full advantage of diversity. The space-time block code is described for instance in Tarokh, V., Jafarkhani, H., Calderbank, A. R.: Space-Time Block Codes from Orthogonal Designs, IEEE Transactions on information theory, Vol. 45, pages 1456 to 1467, July 1999, and in WO 99/14871, which are incorporated herein by reference.

The above-mentioned patent discloses a diversity method where the symbols to be transmitted, which are composed of bits, are encoded in blocks of a given length and each block is encoded into a given number of channel symbols to be transmitted through two antennas. A different signal is transmitted through each antenna. For example, when the symbols to be encoded are divided into blocks with a length of two symbols, the channel symbols to be transmitted are formed so that the channel symbols to be transmitted through a first antenna are composed of the first symbol and the complex conjugate of the second symbol, and the channel symbols to be transmitted through the second antenna are composed of the second symbol and the complex conjugate of the first symbol.

The code provided with a higher symbol rate is disclosed in publication O. Tirkkonen, A. Boariu, A. Hottinen, “Minimal non-orthogonality space-time code for 3+transmit antennas,” in Proc. IEEE ISSSTA 2000, September, NJ, USA. In this code, the signal is transmitted using the following code matrix

$${C}_{NOBSTBC} = [ \begin{matrix}{z}_{1} & - {z}_{2}^{⋄} & {z}_{3} & - {z}_{4}^{⋄} \\ {z}_{2} & {z}_{1}^{⋄} & {z}_{4} & {z}_{3}^{⋄} \\ {z}_{3} & - {z}_{4}^{⋄} & {z}_{1} & - {z}_{2}^{⋄} \\ {z}_{4} & {z}_{3}^{⋄} & {z}_{2} & {z}_{1}^{⋄}\end{matrix} ]$$

Here zᵢ denotes symbols to be transmitted and mark denotes a complex conjugate.

The STBC method functions appropriately, when the receiving end is provided with only one antenna. If both the transmitting end and the receiving end are provided with several antennas, the STBC is suboptimal. In this regard, reference is made to S. Sandhu, A. Pauiraj: Space Time Block Codes: A Capacity Perspective, IEEE Communications letters, Vol 4, No. 12, December 2000, which is incorporated herein by reference.

Another known orthogonal block code is disclosed in publication Lindskog, Paulraj: “A Transmit Diversity Scheme for Channels with Intersymbol Interference”, Proc. IEEE ICC2000, 2000, vol. 1, pages 307 to 311. This code also functions on channels, where intersymbol interference is found (ISI, intersymbol interference).

Still another prior art method is to use several antennas or antenna arrays both in transmission and in reception. This is referred to as the MIMO method (Multiple Input Multiple Output). It has been suggested that the MIMO method yields better results than the methods described above. The MIMO is described in more detail in publication G. J. Foschini, Layered Space-Time Architecture for Wireless Communication in a Fading Environment when Using Multi-Element Antennas, Bell Labs Technical Journal, Autumn 1996, which is incorporated herein by reference. A good capacity can be achieved by the MIMO, assuming that the terminal of the radio system also comprises at least two antennas. Another disadvantage is that the MIMO functions well only if the signals transmitted and received through different antennas travel through different channels. This means that there should be hardly any correlation between the channels. If the channels correlate, the advantage obtained by the MIMO is minimal.

### BRIEF DESCRIPTION OF THE INVENTION

It is an object of the invention to provide a method and an apparatus implementing the method to achieve a good transmission capacity on a wireless connection. This is achieved with a data transmission method between two transceivers, comprising: using more than one radiation pattern for transmitting and receiving a signal in at least one of the transceivers; dividing the symbols to be transmitted into blocks in the first transceiver; encoding the blocks using a first space-time coding; transmitting one block using a radiation pattern; receiving the blocks in the second transceiver using one or more antennas; checking whether retransmission is required in the second transceiver; and if retransmission is required, transmitting a retransmission message to the first transceiver; storing at least some of the blocks in a memory in the second transceiver; encoding at least some of the same blocks using a second space-time coding; retransmitting the encoded blocks from the first transceiver; receiving the retransmitted blocks in the second transceiver using one or more antennas and performing a combined detection or decoding with the blocks in the memory.

The invention also relates to a data transmission method between two transceivers, comprising: using more than one antenna for receiving and transmitting a signal in at least one of the transceivers; dividing the symbols to be transmitted into blocks in the first transceiver, encoding the blocks using space-time coding; transmitting one block from each antenna using a first diversity method; receiving the blocks in the second transceiver using one or more antennas; checking whether retransmission is required in the second transceiver; and if retransmission is required, transmitting a retransmission message to the first transceiver; storing at least some of the blocks in a memory in the second transceiver; encoding at least some of the same blocks using space-time coding; retransmitting the encoded blocks from the first transceiver using a different diversity method than in the first transmission; receiving the retransmitted blocks in the second transceiver using one or more antennas and performing a combined detection or decoding with the blocks in the memory.

The invention also relates to a data transmission method between two transceivers comprising: using more than one radiation pattern for transmitting and receiving a signal in at least one of the transceivers; dividing the symbols to be transmitted into blocks in the first transceiver; encoding the blocks prior to transmission using space-time coding comprising at least two parts; transmitting one block part using a radiation pattern; receiving the blocks in the second transceiver using one or more antennas; selecting the space-time code so that the orthogonality or diversity degree of the combined signal exceeds that of the code parts separately and transmitting the different parts of the space-time code using substantially the same antenna resources but different orthogonal channel resources.

The invention also relates to a data transmission system comprising a first and a second transceiver, the system further comprising: in at least one of the transceivers more than one antenna for transmitting and receiving a signal; and in which system the first transceiver is arranged to divide the symbols to be transmitted into blocks; to encode the block using a first space-time coding, and to transmit one block from each antenna; and in which system the second transceiver is arranged to receive the blocks using one or more antennas.

In the system according to the invention, the second transceiver is arranged to check whether retransmission is required, and if retransmission is required, to transmit a retransmission request to the first transceiver; the second transceiver is arranged to store at least some of the blocks in a memory; the first transceiver is arranged to encode at least some of the same blocks using a second space-time coding; to retransmit the encoded blocks; and the second transceiver is arranged to receive the retransmitted blocks in the second transceiver using one or more antennas and to combine them with the blocks in the memory.

The invention further relates to a data transmission system comprising a first and a second transceiver, and the system also comprising in at least one of the transceivers more than one antenna for transmitting and receiving a signal; and in which system the first transceiver is arranged to divide the symbols to be transmitted into blocks; to encode the block using a first space-time coding, and to transmit one block from each antenna using a first diversity method, and in which system the second transceiver is arranged to receive the blocks using one or more antennas.

In the system of the invention, the second transceiver is arranged to check whether retransmission is required, and if retransmission is required to transmit a retransmission request to the first transceiver; the second transceiver is arranged to store at least some of the blocks in a memory; the first transceiver is arranged to encode at least some of the same blocks using a second space-time coding, to retransmit the encoded blocks using a different diversity method than in the first transmission; and the second transceiver is arranged to receive the retransmitted blocks in the second transceiver using one or more antennas and to combine them with the blocks in the memory.

The invention also relates to a data transmission system comprising a first and a second transceiver, and which system further comprises in at least one of the transceivers more than one antennas for transmitting and receiving a signal; and in which system the first transceiver is arranged to divide the symbols to be transmitted into blocks; to encode the block using a first space-time coding, and to transmit one block from each antenna using a first diversity method; and in which the second transceiver is arranged to receive the blocks using one or more antennas.

In the system of the invention, the second transceiver is arranged to check whether retransmission is required, and if retransmission is required to transmit a retransmission request to the first transceiver; the second transceiver is arranged to store at least some of the blocks in a memory; the first transceiver is arranged to encode at least some of the same blocks using space-time coding, to retransmit the encoded blocks using a different diversity method than in the first transmission; and the second transceiver is arranged to receive the retransmitted blocks in the second transceiver using one or more antennas and to combine them with the blocks in the memory.

Preferred embodiments of the invention are described in the dependent claims.

The present solution describes a new way to utilize space-time block coding and the retransmission to be carried out if need be. The solution according to the invention provides several advantages. A good transmission capacity is achieved without unnecessarily wasting the band. Space-time coding is used in full only when needed; otherwise, partial space-time coding is employed.

In a preferred embodiment of the invention, a signal is divided into blocks, for which a first space-time coding is performed and which are transmitted using more than one antenna. Error checking or reliability metrics calculation is performed in the receiver to find out whether the reception has been successful reliably enough. The signal-to-noise ratio, the reliability of received bits, decoding metrics or other reliability measures may for instance be used as retransmission criteria. In a preferred embodiment, the different parts of the space-time code used for transmission may be provided with a different error checking and retransmission criterion.

If the reception has succeeded, a positive acknowledgement is transmitted if desired. If the reception has failed, then the received blocks are stored in a memory and a negative acknowledgement is transmitted. The transmitter then encodes and transmits at least some of the blocks using a second space-time coding. When the blocks retransmitted in the receiver and previously unsuccessfully received blocks are combined, and are decoded when combined, a higher diversity is obtained or a better orthogonality than with those previously transmitted or with the blocks transmitted a second time alone.

It is possible to use the same space-time coding in both transmissions. Hence, a different diversity can be used in the second transmission than in the first transmission. For example, the blocks can be transmitted using different antennas or radiation patterns, or the signal to be transmitted can be phased differently.

### LIST OF DRAWINGS

In the following, the invention will be described in more detail by means of preferred embodiments, with reference to the accompanying drawings, in which

FIG. 1 illustrates the structure of radio systems,

FIG. 2 illustrates an example of a method,

FIG. 3 shows an example of the coding to be carried out in a transceiver,

FIG. 4 shows another example of the coding to be carried out in the transceiver,

FIG. 5 shows an example of the structure of the transceivers.

### DESCRIPTION OF PREFERRED EMBODIMENTS

The present invention is applicable in various radio systems, in which terminals are provided with different radio path properties. It is irrelevant which multiple access method the system employs. For example, the WCDMA, OFDM and TDMA can be used as the multiple access methods. Possible systems, in which the solutions according to the preferred embodiments of the invention can be applied, are UMTS and EDGE.

Let us clarify some of the terminology used in the application. What a radio system refers to herein is a Radio Access Technology (RAT) in telecommunication systems, which is a part of what is known as an Access Stratum (AS), above which the telecommunication systems comprise a Non Access Stratum (NAS), which employs the services of separate radio systems.

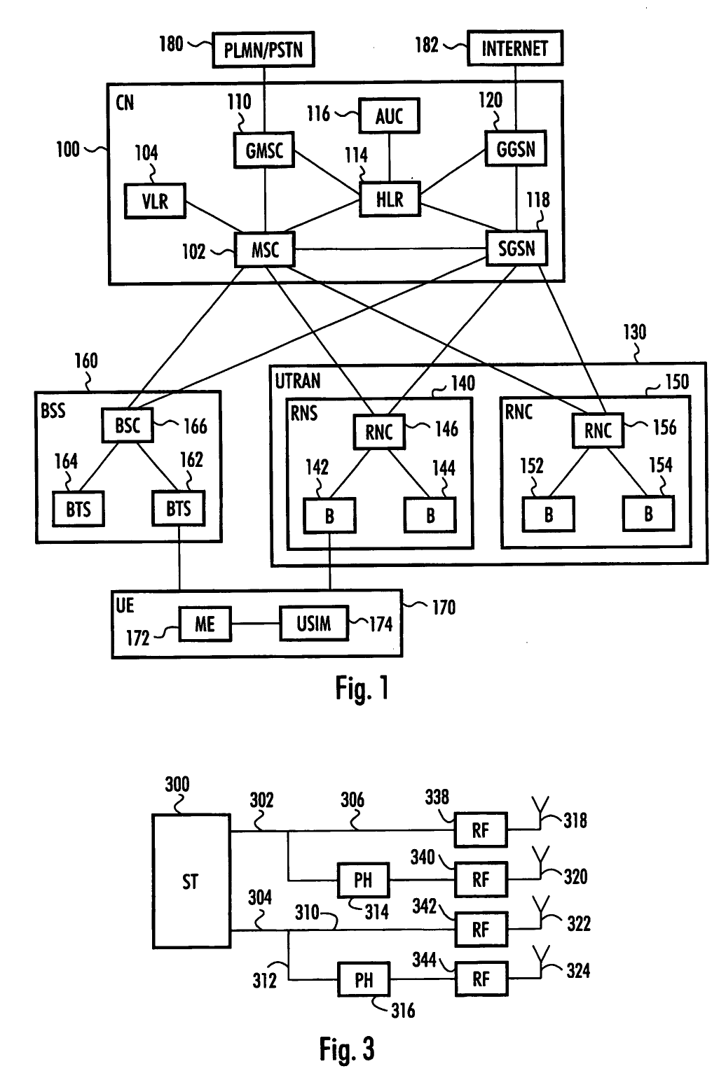

Let us take a closer look at FIG. 1, which illustrates the structure of radio systems. FIG. 1 is a simplified block diagram describing the most important radio system parts at network element level and the interfaces between them. The structure and operation of the network elements are not described in detail, since they are commonly known.

In FIG. 1, a core network CN 100 describes the radio access technology in a telecommunication system. A first radio system i.e. a radio access network 130 and a second radio system i.e. a base station system BSS 160 describe the radio systems. In addition, the Figure shows user equipment UE 170. The term UTRAN refers to the UMTS Terrestrial Radio Access Network, meaning that the radio access network 130 is implemented using Wideband Code Multiple Access WCDMA. The base station system 160 is implemented using Time Division Multiple Access TDMA.

In general, such a definition may also be presented that the radio system is formed of a subscriber terminal, known for instance also by such terms as user equipment and mobile station, and a network part including a fixed infrastructure of the radio system such as a radio access network or a base station system.

The structure of the core network 100 corresponds with the structure of the combined GSM and GPRS systems. GSM network elements are responsible for implementing circuit-switched connections, and GPRS network elements for implementing packet-switched connections, although some of the network elements are included in both systems.

A Mobile Services Switching Centre MSC 102 is the centre of the circuit-switched side of the core network 100. The same mobile services switching centre 102 can be used to serve the connections of both the radio access network 130 and the base station system 160. The functions of the mobile services switching centre 102 include: switching, paging, location registration of user equipment, handover management, collecting subscriber billing information, encryption parameter management, frequency allocation management and echo cancellation. The number of mobile services switching centres 102 may vary: a small network operator may be provided with a single mobile services switching centre 102, but larger core networks 100 may be provided with several.

Larger core networks 100 may comprise a separate Gateway Mobile Services Switching Centre GMSC 110 handling the circuit-switched connections between the core network 100 and external networks 180. The gateway mobile services switching centre 110 is located between the mobile services switching centres 102 and the external networks 180. The external network 180 may for instance be a Public Land Mobile Network PLMN or a Public Switched Telephone Network PSTN.

A Home Location Register HLR 114 includes a fixed subscriber register, or for instance the following information: an International Mobile Subscriber Identity, IMSI, a Mobile Subscriber ISDN Number, MSISDN, an Authentication Key and a PDP address (PDP=Packet Data Protocol) when the radio system supports the GPRS.

A Visitor Location Register VLR 104 includes information concerning roaming on the user equipment 170 within the area of the mobile services switching centre 102. The visitor location register 104 includes largely the same information as the home location register 114, but in the visitor location register 104, the information is placed only temporarily.

An Authentication Centre AuC 116 is physically always located at the same location as the home location register 114, and includes an Individual Subscriber Authentication Key Ki, a Ciphering Key CK and a corresponding IMSI.

The network elements described in FIG. 1 are operational entities, and the physical implementation thereof may vary. Generally, the mobile services switching centre 102 and the visitor location register 104 form together a single physical apparatus, and the home location register 114 and the authentication centre 116 another physical apparatus.

A Serving GPRS Support Node SGSN 118 is the centre of the packet-switched side of the core network 100. The main task of the serving GPRS support node 118 is to transmit and receive packets with the user equipment 170 supporting packet-switched transmission using the radio access network 130 or the base station system 160. The serving GPRS support node 118 includes subscriber data and location information concerning the user equipment 170.

Gateway GPRS Support Node GGSN 120 is the corresponding part on the packet-switched side to the gateway MSC 110 on the circuit-switched side, except that the gateway GPRS support node 120 must be able to route the outgoing traffic from the core network 100 to external networks 182, whereas the gateway MSC 110 only routes the incoming traffic. In this example, the Internet represents the external networks 182.

The first radio system i.e. the radio access network 130 is formed of a radio network subsystem RNS 140, 150. Each radio network subsystem 140, 150 is formed of radio network controllers RNC 146, 156 and of nodes B 142, 144, 152, 154. Node B often refers to the term base station.

The network controller 146 controls nodes B 142, 144 in its domain. In principle, the idea is to place the apparatuses implementing the radio path and the operations associated therewith into nodes B 142, 144 and the control equipment into the radio network controller 146.

The radio network controller 146 handles the following operations: radio resource management of nodes B 142, 144, inter-cell handover, frequency management, or allocation of frequencies to nodes B 142, 144, management of frequency hopping sequences, measurement of time delays in the uplink direction, operation and maintenance, and power control management.

Node B 142, 144 comprises one or more transceivers implementing the WCDMA radio interface. Typically, node B serves one cell, but such a solution is also possible in which node B serves several sectorized cells. The diameter of the cell may vary from a few meters to dozens of kilometres. Node B 142, 144 has the following functions: calculations of timing advance (TA), measurements in the uplink direction, channel coding, encryption, decryption and frequency hopping.

The second radio system, or base station system, 160 is composed of a Base Station Controller BSC 166 and Base Transceiver Stations BTS 162, 164. The base station controller 166 controls the base transceiver station 162, 164. In principle, the aim is to place the equipment implementing the radio path and the functions associated therewith in the base station 162, 164 and to place the control equipment in the base station controller 166. The base station controller 166 handles substantially the same functions as the radio network controller.

The base transceiver station 162, 164 includes at least one transceiver implementing a carrier, or eight time slots, or eight physical channels. Typically, one base station 162, 164 serves one cell, but such a solution is also possible, in which one base station 162, 164 serves several sectorized cells. The base station 162, 164 is considered to also include a transcoder, which carries out the conversion between the speech-coding mode used in the radio system and the speech-coding mode used in the public switched telephone network. However, in practice the transcoder is typically physically placed in the mobile services switching centre 102. The base transceiver station 162, 164 is provided with corresponding functions as node B.

The subscriber terminal 170 is composed of two parts: mobile equipment ME 172 and a UMTS Subscriber Identity Module, USIM 174. The subscriber terminal 170 includes at least one transceiver that implements the radio connection to the radio access network 130 or to the base station system 160. The subscriber terminal 170 comprises at least two different subscriber identity modules. In addition, the subscriber terminal 170 comprises an antenna, user equipment and a battery. Many kinds of subscriber terminals 170 currently exist, for instance vehicle-mounted and portable terminals.

The USIM 174 includes information associated with the user, and in particular information associated with information security, for instance a cryptographic algorithm.

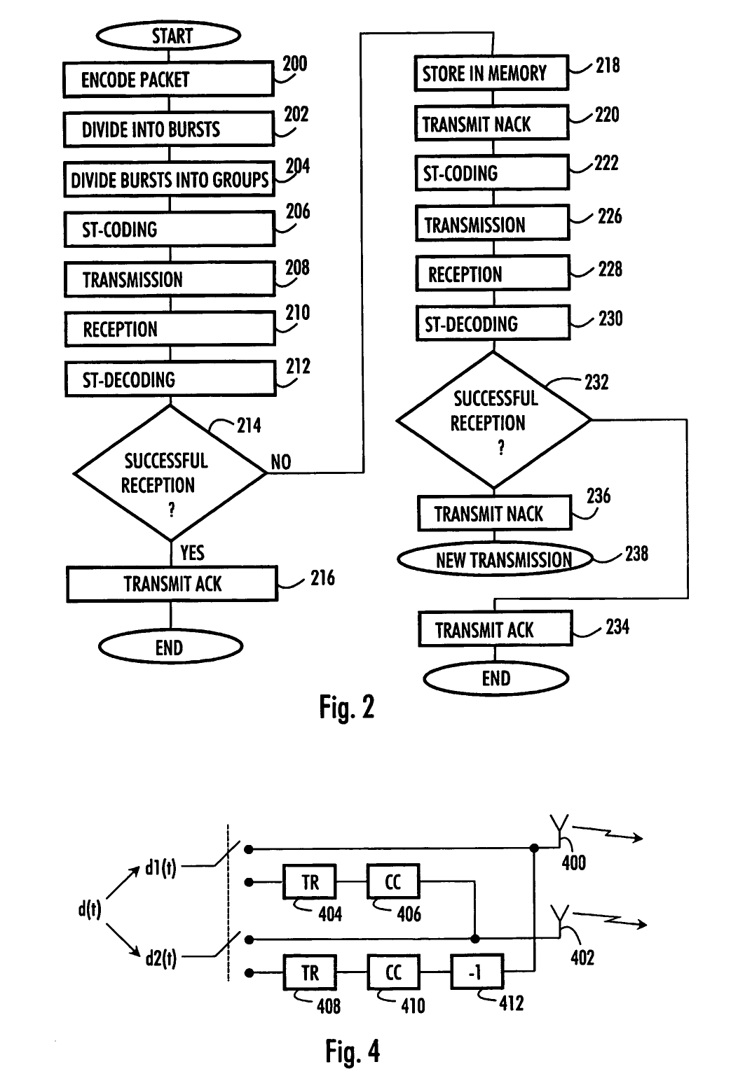

Let us take a closer look at a solution according to a preferred embodiment shown in the flow chart of FIG. 2. The information packet to be transmitted is encoded in a first transceiver and divided into different blocks in step 200, as described earlier. In step 202, the block to be transmitted is divided into separate bursts. In an alternative implementation, the number of bursts is divisible by the number of antennas used in the transmission, which is referred to as nT. Next, in step 204, the bursts are divided into an nT group, which are encoded in step 206 using space-time coding. Each one of the groups is transmitted from a specific antenna in step 208.

In step 210, the second transceiver receives the bursts and performs space-time coding 212. In step 214, the transceiver checks, if the reception has been successful. If the reception has been successful, the second transceiver transmits a positive acknowledgement to the first transceiver in step 216.

It should be noted herein that several groups can be transmitted before an acknowledgement is transmitted.

If the reception has not been successful reliably enough, then the second transceiver stores the bursts temporarily in a memory in step 218 and transmits a negative acknowledgement to the first transceiver in step 220. Next in step 222, the same nT bursts are re-encoded using space-time coding, which is different to the one used in the previous transmission. The groups are transmitted in step 226.

In step 228, the second transceiver receives the bursts and in step 230, the second transceiver reads the stored bursts from the memory and performs space-time coding. In step 232, the second transceiver checks, if the reception has been successful. If the reception has been successful, the second transceiver transmits a positive acknowledgement to the first transceiver in step 234.

If the reception has failed, the second transceiver transmits a negative acknowledgement to the first transceiver in step 236. Next, the process proceeds to step 238 to retransmit the same bursts in accordance with step 204.

When all groups have been transmitted, the process proceeds to transmit the second block of step 200 and the procedure is continued until the entire date packet has been successfully transmitted.

An automatic repeat request method (ARQ) is by way of example applied to the presented solution in connection with space-time coding. In other words, a space-time encoded symbol block is transmitted at first to the second transceiver. If the reception has been successful, the transmission of the ARQ channel blocks may be continued. The ARQ protocol may naturally be arbitrary (for example a Hybrid N channel ARQ protocol). Otherwise, the symbol block or a part thereof is retransmitted using a second space-time coding. Then, the orthogonality of the signal combined in the second transceiver is higher than the orthogonality in the first or second transmission alone. If a different diversity method is employed in the latter transmission, the diversity degree of the combined signal in the second transceiver is higher than the diversity degree in the first or second transmission alone.

Let us next take a closer look at a preferred embodiment. A known space-time coding method for two transmission antennas is described in the following. Symbols S to be transmitted and composed of bits are encoded in blocks of a given size, and in which each block is encoded to a given number of channel symbols in accordance with the following formula.

$${C}_{Ala} -> ( \begin{matrix}{S}_{1} & {S}_{2} \\ - {S}_{2}^{⋄} & {S}_{1}^{⋄}\end{matrix} ) \qquad ( 1 )$$

In the formula, the horizontal lines in the matrix denote transmission time instants so that the upper horizontal line describes the information to be transmitted at time instant t and the lower horizontal line the information to be transmitted at time instant t+T, where T refers to a symbol sequence. Mark [symbol] refers to a complex conjugate. The vertical lines in the matrix in turn depict antennas so that the first vertical line describes the information transmitted through an antenna 1 and the second vertical line the information transmitted through an antenna 2. The block code of complex modulation shown in the formula thus exists, although only for two antennas at the most. In the above example, symbols S₁ and S₂ are transmitted at time instant t and symbols −S₂ [symbol] and S₁ [symbol] at time instant t+T.

An application of the above code for three or four antennas is the so-called ABBA code, which is described in the following equation

$${C}_{ABBA} ( {S}_{1} , {S}_{2} , {S}_{3} , {S}_{4} ) = [ \begin{matrix}C ( {S}_{1} , {S}_{2} ) & C ( {S}_{3} , {S}_{4} ) \\ C ( {S}_{3} , {S}_{4} ) & C ( {S}_{1} , {S}_{2} )\end{matrix} ] \qquad ( 2 )$$

A corresponding effective space-time filter for the code in formula (1) is

$$H ( {α}_{1} , {α}_{2} ) = [ \begin{matrix}{α}_{1} & {α}_{2} \\ {α}_{2}^{*} & - {α}_{1}^{*}\end{matrix} ] \qquad ( 3 )$$

and for the code in formula (2)

$$H ( {α}_{1} , {α}_{2} , {α}_{3} , {α}_{4} ) = [ \begin{matrix}H ( {α}_{1} , {α}_{2} ) & H ( {α}_{3} , {α}_{4} ) \\ H ( {α}_{3} , {α}_{4} ) & H ( {α}_{1} , {α}_{2} )\end{matrix} ] . \qquad ( 4 )$$

Thus, the effective correlation matrix for the code in formula (2) observed by the receiver is

$${H}_{ABBA}^{H} {H}_{ABBA} = [ \begin{matrix}a & 0 & b & 0 \\ 0 & a & 0 & b \\ b & 0 & a & 0 \\ 0 & b & 0 & a\end{matrix} ] , \qquad ( 5 )$$

where b=2Re[α₁,α*₃+α₂,α*₄] and a=Σ|αᵢ|², and αᵢ are complex channel coefficients between antenna i and the receiving antenna.

When the ARQ method is applied to the above coding, the first blocks can be transmitted first as described above. If retransmission is required, the blocks can be retransmitted so that the phasing used is changed or alternatively the channels should be rearranged. In a preferred embodiment, the signals of the third and fourth antennas can be multiplied by coefficient −1. Then the correlation coefficient is obtained from the following equation:
b=2Re[α₁[t1]α₃[t1]*+α₂[t1]α₄[t1]*−α₁[t2]α₃[t2]*−α₂[t2]α₄[t2]*]
and the sum energy as the sum energy of two diagonals. The retransmission need not necessarily be received or transmitted with the same amount of power as the first transmission. However, full orthogonality is achieved only if the received signal power in both transmissions is of the same size, and especially if the channel phases of both transmissions are equal. This is highly likely, if retransmission occurs within the coherence time of the channel. Since the transmission is orthogonalized after retransmission, a simple receiver algorithm typically suffices for detecting the combined signal.

Let us next take a closer look at another preferred embodiment. Another code, which is herein referred to as a converted code, can be defined in such a manner that the code is provided with insignificant loss on the AWGN (Average White Gaussian Noise) channel and with adequate capacity on a multipath Rayleigh and Rician fading channel. Let us first define the terms
X₁=C(S₁, S₂)−C(S₃, S₄) (6)
X₂=C(S₁, S₂)+C(S₃, S₄) (7)
that allow indicating the code matrix as follows

$$C ( {S}_{1} , {S}_{2} , {S}_{3} , {S}_{4} ) = [ \begin{matrix}{X}_{1} & 0 \\ 0 & {X}_{2}\end{matrix} ] , \qquad ( 8 )$$

or in a slightly converted form

$$C ( {S}_{1} , {S}_{2} , {S}_{3} , {S}_{4} ) = \frac{1}{2} * [ \begin{matrix}{X}_{1} & {X}_{2} \\ {X}_{1} & - {X}_{2}\end{matrix} ] . \qquad ( 9 )$$

Here, the columns in the matrix are transmitted using different radiation patterns. Assuming that the channel is constant over four symbol sequences, the following code correlation matrix is obtained

$${H}^{H} H = [ \begin{matrix}a & 0 & b & 0 \\ 0 & a & 0 & b \\ b & 0 & a & 0 \\ 0 & b & 0 & a\end{matrix} ] , where \\ a = {\sum }_{i = 0}^{{N}_{t}} {\vert {α}_{i} \vert}^{2} and b = {\sum }_{i = 0}^{{N}_{t}} {\vert {α}_{i} \vert}^{2} - {\sum }_{i = {N}_{t} / 2 + 1}^{{N}_{t}} {\vert {α}_{i} \vert}^{2} , \qquad ( 10 )$$

where Nₜ is the number of transmission antennas. When the ARQ method is applied in the above coding, the first blocks can be transmitted at first as shown above. If retransmission is required, then the blocks can be retransmitted so that the antenna (or radiation pattern) used for transmitting two STTD branches is changed. Thus, the following formula determines the non-orthogonality:

$$b = {\sum }_{i = 0}^{{N}_{t} / 2} {\vert {α}_{i} [ t1 ] \vert}^{2} - {\sum }_{i = {N}_{t} / 2 + 1}^{{N}_{t}} {\vert {α}_{i} [ t1 ] \vert}^{2} + {\sum }_{i = {N}_{t} / 2 + 1}^{{N}_{t}} {\vert {α}_{i} [ t2 ] \vert}^{2} - {\sum }_{i = 0}^{{N}_{t} / 2} {\vert {α}_{i} [ t2 ] \vert}^{2}$$

In this example full orthogonality is achieved only if the channel powers are similar (irrespective of the phases) during transmission, so that b=0. During each retransmission, the antennas (or radiation patterns) to be used for transmitting different STTD branches can be varied and consequently the effective correlation decreases after each retransmission.

Let us next examine a transmitter provided with Nₜ transmission antennas and quadratic space-time code matrixes. Let us say that C₁∈C^{Nt/2×Nt/2} and C₂∈C^{Nt/2×Nt/2} refer to the freely selectable orthogonal space time block codes of coding ratio r, where C is a set of complex matrixes. Let us say that U represents a unitary matrix, for example in the following form

$$U ( α , ϕ ) = [ \begin{matrix}μ & υ \\ - {υ}^{*} & {μ}^{*}\end{matrix} ] ⊗ {I}_{{N}_{t} / 2} \qquad ( 11 )$$

where μ=\sqrt{α} and ν=\sqrt{1−α}e^{-jφπ}. A simple presentation for the code is obtained by providing a space-time matrix:

$${C}_{tr} = [ \begin{matrix}1 & 0 \\ 1 & 0\end{matrix} ] ⊗ {\tilde{C}}_{1} + [ \begin{matrix}0 & 1 \\ 0 & - 1\end{matrix} ] ⊗ {\tilde{C}}_{2} \qquad ( 12 )$$

where
   \tilde{C}₁=C₁(y₁, . . . ,y_{Nt/2}),
   \tilde{C}₂=C₂(y_{Nt+1}, . . . ,y_{Nt}),
   and
   (y₁, . . . ,y_{Nt})=(s₁, . . . ,s_{Nt})U^{T}(α,φ).

Multiplexing the space-time matrixes in accordance with formula (12) provides all the antenna elements at all times with the same average power. Other orthogonal multiplexing methods can also be used, such as antenna hopping, whereby the code corresponding to equation (12) should be in the following form

$${C}_{tr} = [ \begin{matrix}1 & 0 \\ 0 & 0\end{matrix} ] ⊗ {\tilde{C}}_{1} + [ \begin{matrix}0 & 0 \\ 0 & 1\end{matrix} ] ⊗ {\tilde{C}}_{2} .$$

Parameter α (or more generally the amplitude difference between terms μ and ν in formula (11)) allows creating different transmission methods, starting from homogeneous methods regarding orthogonal symbols, in which all symbols are treated equally, and ending up with orthogonal methods, in which each symbol is transmitted from half the number of antennas, thus reducing the effective transmit diversity.

The received signal is indicated in the following form when converted code is used
r=Cₜᵣh+n.
It is possible to indicate the above formula using an effective channel matrix in the following form: \tilde{r}=HUs+n, where \tilde{r} is obtained from r using complex conjugates and linear conversions. Let us assume that the number of receiving antennas is Nᵣ., and that α=0,5. Then, the correlation matrix of the converted code is

$${U}^{H} {H}^{H} H U = a {I}_{{N}_{t}} + [ \begin{matrix}0 & b \\ {b}^{*} & 0\end{matrix} ] ⊗ {I}_{{N}_{t} / 2} , \qquad ( 13 )$$

where H is defined in formula (4) and

$$\begin{matrix}a = {\sum }_{j = 1}^{{N}_{r}} {\sum }_{i = 1}^{{N}_{t}} {\vert {h}_{i , j} \vert}^{2} and & ( 14 ) \\ b = {ⅇ}^{jπϕ} ( {\sum }_{j = 1}^{{N}_{r}} {\sum }_{i = 1}^{{N}_{t} / 2} {\vert {h}_{i , j} \vert}^{2} - {\sum }_{j = 1}^{{N}_{r}} {\sum }_{i = {N}_{t} / 2 + 1}^{{N}_{t}} {\vert {h}_{i , j} \vert}^{2} ) . & ( 15 )\end{matrix}$$

Let us assume that signal according to formula (12) is being transmitted. Two space-time codes \tilde{C}₁ and \tilde{C}₂ are transmitted in parallel from four antennas. When parameter α has the value α=1,0, the transmission is of what is known as DSTTD (Double STTD) mode. Generally, the transmission of symbol rate 2 can be described using matrix

$$C ( {s}_{1} , … , {s}_{8} ) = [ \begin{matrix}{\tilde{C}}_{1} & {\tilde{C}}_{3} \\ {\tilde{C}}_{4} & {\tilde{C}}_{2}\end{matrix} ] , \qquad ( 16 )$$

where \tilde{C}₃ modulates symbols s₅ and s₆ and \tilde{C}₄ modulates symbols s₇ and s₈. More specifically, during the first space-time code block, \tilde{C}₁ and \tilde{C}₂ are transmitted in parallel and the same capacity is obtained as with formula (16).

An application in connection with the converted code, in which the decoding delay of the sub-code is 2, is the following: Value α=1,0 is used for parameter α. Transmission takes place at time instant t1
Cₜᵣ₁[t1]=[\tilde{C}₁ \tilde{C}₂] (17)
and, if required, retransmission occurs at time instant t2=t1+N
   Cₜᵣ₂[t+N]=[\tilde{C}₁ −\tilde{C}₂] (18)
   If the individual symbols are QPSK modulated, and α=1,0, then the bit rate during the first transmission is 4 bits/s/Hz. If retransmission is required, the effective bit rate is 2 bits/s/Hz.

If retransmission occurs within the coherence time of the channel, the code (defined over t1 and t2) is identical with the STTD-OTD, i.e. orthogonal. Thus, when using the retransmission described above, the original DSTTD transmission is converted into an STTD-OTD transmission when the original transmission and retransmission are combined in the receiver. A similar situation also occurs if instead of the above-mentioned decoding delay of 2 symbols a 4×4 matrix (12) is used in the first transmission, where α=1, and a 4×4 matrix in the retransmission, where α=0. Consequently, both transmissions are separately STTD-OTD transmissions, however, so that the combined transmission is orthogonal (if it takes place along the same channels). It is also possible to operate in such a manner that the two first transmissions are transmitted as Cₜᵣ₁ and Cₜᵣ₂ above (thus corresponding for example to the STTD-OTD transmission when α=1) and a possible third transmission is a 4×4 matrix that corresponds to the STTD-OTD transmission with parameter α=0. In other words, the retransmission can be applied to the previous integrated space-time code preferably so that the orthogonality increases.

SUD-OTD (OTD, Orthogonal Transmit Diversity) coding is known per se, and is therefore not explained in more detail herein. However, it should be noted by way of example that in the coding concerned, four data flows are for instance obtained, which can be directed to different radiation patterns. The coding is indicated in the following form:

$$[ \begin{matrix}{x}_{1} & {x}_{2} & {x}_{3} & {x}_{4}\end{matrix} ] -> \begin{matrix}TxA1 \text{:} \\ TxA2 \text{:} \\ TxA3 \text{:} \\ TxA4 \text{:}\end{matrix} [ \begin{matrix}{x}_{1} & {x}_{1} & {x}_{2} & {x}_{2} \\ - {x}_{2}^{⋄} & - {x}_{2}^{⋄} & {x}_{1}^{⋄} & {x}_{1}^{⋄} \\ {x}_{3} & - {x}_{3} & {x}_{4} & - {x}_{4} \\ - {x}_{4}^{⋄} & {x}_{4}^{⋄} & {x}_{3}^{⋄} & - {x}_{3}^{⋄}\end{matrix} ] \times \frac{1}{2} ,$$

where ½ denotes the normalization coefficient of transmission power. Each horizontal line in the matrix represents a signal to be transmitted using one radiation pattern. Multi-code spread can be carried out for each one of the four data flows, where the same spreading codes are used for each data flow. In multi-code spread the signal (at least two space-time matrixes, for instance) is transmitted using parallel spreading codes, ODFM carriers, a multi-carrier method or any parallel modulation method. It should be observed that the signal to be transmitted through all radiation patterns is orthogonal, in other words the lines in the matrix (7) are orthogonal.

If α≠1,0 with the full diversity modulation constellation, then the bit rate of the first transmission is 4 bits/s/Hz and the same bits are transmitted at time instant t2, and then the bit rate obtained is 2 bits/s/Hz. These a values will not change the code structure in connection with retransmission. The code is therefore provided with a 4-degree diversity after a retransmission when four antennas are used. It should be noted that t1 and t2 can also be replaced with other channel resources than time, such as transmission frequency (frequency hopping), carrier frequency, a different spreading code.

Let us next take a closer look at an example, in which only two transmission antennas are used and the first transmission is indicated in the form \tilde{C}₁. The bit rate in the first transmission is 2 bits/s/Hz, if α=0,1 and 4 bits/s/Hz if α≠0,1.

Let us assume that α=0.5 and retransmission is requested and it takes place within the coherence time of the channel. If the code is integrated/decoded only based on the first transmission, it obtains a bit rate of 4 bits/s/Hz, but if the code is integrated/decoded based on both transmissions, it obtains a bit rate of 2 bits/s/Hz and the code is orthogonal. If α=0.5 and retransmission does not take place within the coherence time (or coherence frequency) of the channel, the code is non-orthogonal with the following correlation structure:

$${U}^{H} {H}^{H} H U = a {I}_{{N}_{t}} + [ \begin{matrix}0 & b \\ {b}^{⋄} & 0\end{matrix} ] ⊗ {I}_{{N}_{t} / 2} \qquad ( 19 )$$

where H is defined in formula (4) and

$$a = {\sum }_{j = 1}^{T} {\sum }_{i = 1}^{{N}_{t}} {\vert {h}_{i , {t}_{j}} \vert}^{2} and$$

$$b = {ⅇ}^{j πϕ} ( {\sum }_{j = 1}^{T} {\sum }_{i = 1}^{{N}_{t} / 2} {\vert {h}_{i , {t}_{j}} \vert}^{2} - {\sum }_{j = 1}^{T} {\sum }_{i = {N}_{t} / 2 + 1}^{{N}_{t}} {\vert {h}_{i , {t}_{j}} \vert}^{2} )$$

where h_{i,t} denotes a channel coefficient from a transmission antenna i to a receiving antenna at time instant tⱼ (or in analogue mode at frequency fⱼ). For the sake of simplicity, it is assumed that only one receiving antenna is provided. The degree of diversity is thus four, when decoding occurs from both transmissions. If the first transmission has been successful, the bit rate increases when a second-degree diversity transmission is used, and if it failed, the diversity degree and/or transmission power increases after the decoding of the combined transmission. In order to achieve this, form \tilde{C}₁ has to be used in the first transmission and form \tilde{C}₂ in both transmissions as well as value α≠0,1. It should be noted that if the channel does not change for different block parts, the code is orthogonal but the diversity degree does not increase either.

Let us next examine another embodiment that can preferably be applied for instance in such a case, where it is assumed a priori in the above transmission that the first transmitted part with the given channel statistics is unreliable. It is assumed that two transmission antennas are used and that the space-time code to be used in the transmission includes at least two parts. The first part of the code is used in the first transmission using specific resources. The second transmission is carried out using the second part of the code and other resources. The transmissions may occur for instance so that the first part is transmitted at time instant t1 in the first time slot, and the second transmission at time instant t2=t1+N in the second time slot using at least partly different channels. The transmission antennas are the same, but for example the time slot, the frequency or the sub-carrier may deviate in comparison with the transmission of the first part, so that the different parts of the space-time code are received at least partly by different channel coefficients. Transmission is thus carried out in such a manner that the receiver observes the different channels with the signals.

An example of the above transmission method is to transmit the code according to formula (1) rotated from two antennas at time instant t1 (previously denoted with \tilde{C}₁). The second transmission (\tilde{C}₂) is transmitted at time instant t2 using the same antennas.

Another example is to transmit \tilde{C}₁ in time slot t1 and \tilde{C}₂ in time slot t2 so that t1+N is deterministic. Time instant t1 and t2 may be replaced in these examples for instance with frequencies or (sub)carriers.

It is preferable above if the space-time code parts are transmitted onto different channels. If it is desired to artificially form at least partly non-correlated channels, then the procedure may proceed as follows. Let us assume that for instance four antennas are being used, which transmit, however, so that the receiver sees only two channels. Then, substantially at time instant t1 transmissions are carried out to two different linear combinations or radiation patterns and at time instant t2 to two different radiation patterns, whereof at least one is different than the one used at time instant t1. The channels can be formed in accordance with the prior art for instance using continuous frequency offset, applied to at least one transmission antenna, phase hopping as in the trombi code described below, changing the indexing of antennas, and the like. Here, two block parts are transmitted at time instant t1 to the radiation patterns or channels and at time instant t2=t1+N at least partly to the different radiation patterns/channels.

In this embodiment, the decision on whether to transmit the second code part at time instant t1+N may be based on whether the decoding of the signal transmitted at time instant t1 has been successful reliably enough. In an alternative transmissions are carried out at time instants t1 and t2=t1+N anyway, but a possible retransmission is carried out at time instant t1+N2 depending on whether the combined t1 and t2 transmission is decoded reliably. N and N2 may be determined quantities agreed upon by the transmitter and the receiver or quantities determined by the transmitter. What is also emphasized is that the time resource can be changed above into a frequency resource, or to another substantially orthogonal resource, such as a code, a frequency, time or a combination thereof.

Let us next examine another preferred embodiment, which is herein referred to as trombi. It is assumed in this example for the sake of clarity that the first transceiver is a base station and the second transceiver is a subscriber terminal. It is assumed herein that the base station carries out the coding of the signal to be transmitted in accordance with formula (1). Thus, two data flows are obtained. Each data flow is divided into two, and one half of both data flows is multiplied by phase terms e^{θ1} and e^{θ2} where {θ₁} and {θ₂} denote phase hopping sequences. FIG. 3 illustrates coding. An encoder 300 performs the coding in accordance with formula (1) for the signal to be transmitted, and the output of the encoder includes two data flows 302 comprising symbols S1 and S2 and 304 comprising symbols −S2 [symbol] and S1 [symbol] . These data flows are divided into two branches, i.e. the data flow 302 is divided into branches 306 and 308, and the data flow 304 is divided into branches 310 and 312. The data flows 306 and 310 are forwarded as such, but the data flow 308 is applied to a phase transfer means 314, where a phase shift e^{θ1} is caused thereto. Correspondingly, the data flow 312 is applied to a phase shift means 316, where a phase shift e^{θ2} is caused thereto. The phase shift may be different for each data flow or similar for all of them. In this example, the phase shift is different.

The data flows 306 to 312 are applied to radio frequency units 338 to 344 and transmitted using radiation patterns 318 to 324. The radiation patterns can be achieved using four different antennas, or one or more antenna arrays, as is apparent for those skilled in the art. It is not essential herein, how the radiation patterns are formed.

In connection with a possible retransmission, the used antennas or radiation patterns can be changed, or the phasing of the radiation patterns can be altered.

Let us next take a closer look at another preferred embodiment. Let us examine a method shown in FIG. 4, in which the symbol rate of the first transmission is the same as in code (17) above, but in which the code is applied to a multipath-channel.

Let us apply herein the transmission described above, in which the data flows are divided. Let us divide the data d(t) to be transmitted into two halves, d1(t) and d2(t). Let us also divide the frame to be used in the transmission into two halves. During the first half of the frame, d1(t) is transmitted from antenna 400 and d2(t) is transmitted from antenna 402. During the second half of the frame, d1(t) is turned into reversed order in a inverter 404, a complex conjugate is taken thereform in calculation means 406 and it is transmitted from the antenna 402. Correspondingly, d2(t) is turned into reversed order in a inverter 408, a complex conjugate is taken therefrom and the sign is turned in calculation means 410 and transmission is carried out from the antenna 400.

In the accompanying formula, the code in equation (1) is included in the outermost layer of the code shown in the formula:

$$[ \begin{matrix}{z}_{1} & {z}_{2} & … & {z}_{2 n - 1} & ARQ & {z}_{2 n}^{⋄} & … & {z}_{4}^{⋄} & {z}_{2}^{⋄} \\ {z}_{2} & {z}_{4} & … & {z}_{2 n} & viive & - {z}_{2 n - 1}^{⋄} & … & - {z}_{3}^{⋄} & - {z}_{1}^{⋄}\end{matrix} ]$$

This means that z₁ and z₂ are in the first symbol period and z₂ [symbol] and −z₁ [symbol] are in the last symbol period, however, so that the signs of the last terms have been changed. This does not affect the orthogonality. A corresponding code is also found in the next layer as symbols z₃ and z₄, and so on for each following pair of symbols, continuing until symbols z₂ₙ₋₁ and z₂ₙ. The last part of the matrix is transmitted if the receiver requests it. In this case, the signal model may be depicted as follows on a multipath channel:

The convolution matrix of a channel comprising L propagation paths is indicated, the matrix including T lines (symbols) in the formula

$$M ( {α}_{1} , {α}_{2} , … , {α}_{L} ) = {[ \begin{matrix}{α}_{1} & {α}_{2} & ⋯ & {α}_{L} & 0 & 0 & 0 \\ 0 & {α}_{1} & {α}_{2} & ⋯ & {α}_{L} & 0 & 0 \\ 0 & 0 & ⋰ & ⋰ & ⋰ & ⋰ & 0 \\ 0 & 0 & 0 & ⋯ & {α}_{1} & {α}_{2} & {α}_{L}\end{matrix} ]}^{T}$$

The first transmission of blocks is provided with an effective channel matrix
H₁=[M(α_{1,1}, α_{1,2}, . . . , α_{1,L}) M(α_{2,1}, α_{2,2}, . . . , α_{2,L})],
and the second transmission with
H₂=[−M(α*_{2,L-1}, α*_{2,L-1}, . . . , v*_{2,1}) M(α*_{1,L}, α*_{1,L-1}, . . . , α*_{1,1})].

The effective correlation matrix can now be indicated as
H^{H}₁ H₁+H^{H}₂ H₂.

The first transmission suffices to decode the symbols, especially when several non-correlated transmission/receiving antennas are used, and if the signal-to-noise ratio is sufficiently high. A corresponding block transmission concept can be applied also for non-orthonalized codes.

If the first two lines of the ABBA code (formula 2) are used with four transmission antennas as the basic transmission method, then the first transmission is of DSTTD form (symbol rate 2). Then, after the retransmission that has taken place within the coherence time, the code is converted into ABBA form (symbol rate 1). If two receiving antennas are used, whereby the decoding of the DSTTD is easier, the diversity degree of the first transmission is four and eight after retransmission. Consequently, after the combined decoding the detection probability increases significantly, and the transmission is at the same time spectrum efficient.

If the trombi-form transmission or STTD-OTD transmission (i.e. orthogonal transmission of limited diversity by means of diversity degree 2) is used in the first transmission, the retransmission occurring within the coherence time of the channel can be modified in such a manner that a full diversity orthogonal code is obtained after the combination, as is previously mentioned. If retransmission occurs with a different power than the first transmission or if the channel amplification has changed, full diversity is not achieved. However, typically the process comes close to full diversity. The antennas used can be permutated in the transmission or the phasing of the antennas may be changed.

If the first transmission employs the previously described converted code using symbol rate 1, then formula (15) depicts the correlation structure. When the indexes to be used in retransmission have been changed, a value is obtained for the correlation structure of the combined signal

$$b = {ⅇ}^{jπϕ} ( {\sum }_{j = 1}^{{N}_{r}} {\sum }_{i = 1}^{{N}_{t} / 2} ( {\vert {h}_{ij} [ t1 ] \vert}^{2} - {\vert {h}_{ij} [ t2 ] \vert}^{2} ) - {\sum }_{j = 1}^{{N}_{r}} {\sum }_{i = {N}_{t} / 2 + 1}^{{N}_{t}} ( {\vert {h}_{ij} [ t1 ] \vert}^{2} - {\vert {h}_{ij} [ t2 ] \vert}^{2} ) ) ,$$

which substantially indicates that the correlation decreases to zero if the channels are similar during both transmissions. The same result is obtained, if the first transmission is of ABBA type, except that the complex phase must be changed (multiplied by value −1) for instance in antennas 1 and 2.

If the previously described converted code is used in the first transmission using symbol rate 2 (the code matrix being of size 4×4), then the diagonal correlations can be made non-existent with the method described in the previous paragraph or simply by setting the values of φ₁ determining the unitary conversion of the first transmission and φ₂ determining the unitary conversion of the second transmission so that
e^{jπφ1=-e}^{jπφ2}.
Thus, the non-diagonal terms in the correlation matrix ideally annul one another.

If for instance four transmission antennas are in use, the transmission can be carried out according to the following matrix, whereby the symbol rate of the 4×4 matrix is also 2:

$${C}_{2 TR - AHOP} = [ \begin{matrix}X1 & X3 \\ X4 & X2\end{matrix} ]$$

In all the above cases, the channel coefficients α may generally depend on for example radiation patterns and describe the channel seen by the receiver, and may be linear conversions of the channel coefficient in each transmission element and receiving element. Different patterns may be provided with a different space-time code part, and each beam can be optimized either using closed loop control or blindly by means of the received signal.

The examples described in the above paragraphs can also be combined as desired, for instance when using more than one retransmission, so that the final combined code is at least partly orthogonal or more orthogonal, or more reliable than the previously combined transmission.

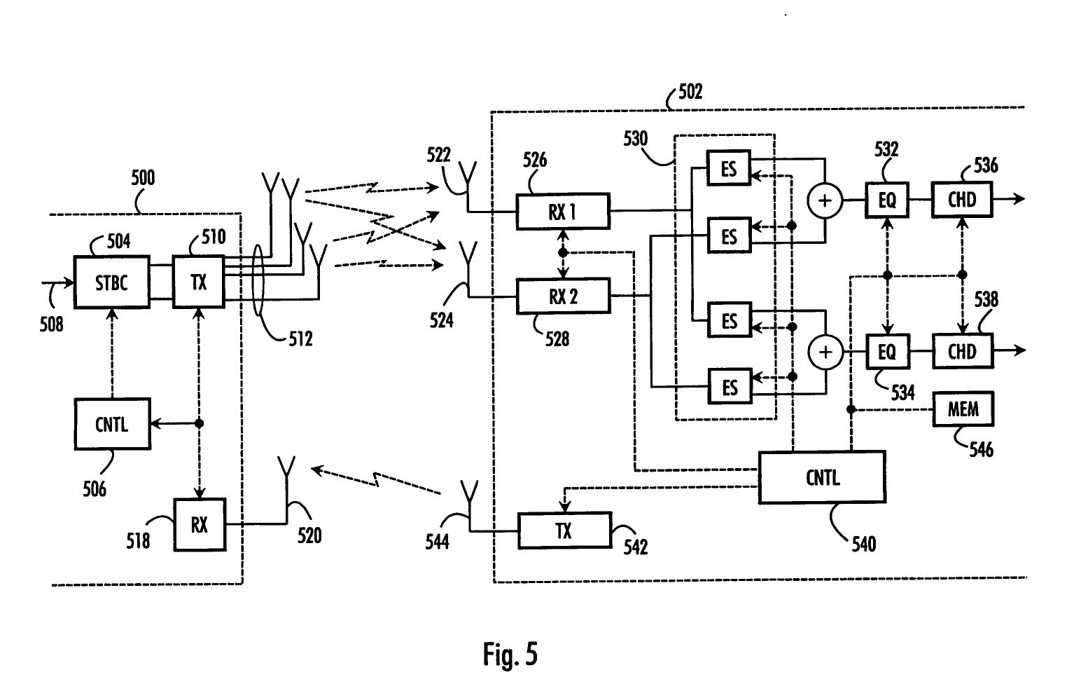

Let us examine in the following examples of transceivers according to the preferred embodiments shown in FIG. 5. The Figure shows the essential parts of a first transceiver 500 and a second transceiver in view of the invention. The transceivers comprise other components too, as is obvious for those skilled in the art, but these have not been described in this context. The first transceiver comprises a space-time block encoder 504, into which a signal 508 to be transmitted is provided as input. In an ST encoder the signal is encoded using a first space-time coding. The encoded signal is applied to radio frequency parts 510, in which they are amplified, transferred to a radio frequency and transmitted using antennas 512. A diversity method can be used in transmission. The antennas 512 correspond to the antennas 318 to 324 shown in FIG. 3. The encoder 504 in turn corresponds to the components 300, 314 and 316 shown in FIG. 3. A control block 516 controls the operation of the different parts in the first transceiver. The ST encoder 504 as well as the control block can be implemented for instance by a processor and appropriate software, or using separate components or a combination of the processor and the components and appropriate software. The radio frequency parts 510 can be implemented in accordance with the prior art.

The first transceiver further comprises receiver parts 518 and a receiving antenna 520. In a practical receiver, the transmission and receiving antennas are generally the same ones.

In this example, the second transceiver 502 comprises two receiving antennas 522, 524, which carry out the reception of the signal and corresponding radio frequency parts 525, 528, to which the signal received by the antennas is applied, and in which the signal is converted into intermediate frequency or baseband. The signal received from radio frequency parts is applied to a pre-filter 530, in which the signals transmitted by different antennas are separated from one another. This may occur in many ways known to those skilled in the art. One method is the interference elimination method, in which desired signal is received and the other signals are treated as interference. In the pre-filter, efforts are made to remove interference and to reduce the impulse response of the desired signal.

From the intermediate filters, the signals are applied to equalizers 532, 534, in which the signal is further frequency corrected for instance using a delayed decision feedback sequence estimator (DDFSE) and a maximum a posteriori probability (MAP) estimator connected in series thereto. Frequency correction and pre-filtering may be based on, for example, minimum mean-square error decision feedback equalization (DFE). From the equalizer the signal is applied to channel decoders 536, 538.

A control block 540 controls the operation of the different parts in the second transceiver. The equalizers 532, 534, as well as the control block, can be implemented for instance by a processor or appropriate software, or using separate components or a combination of the processor and the components and appropriate software. The radio frequency parts 526, 528 can be implemented in accordance with the prior art.

The second transceiver further comprises transmitter parts 542 and a receiving antenna 544. In a practical receiver, the transmission and receiving antennas are typically the same ones.

In the second transceiver, the channel decoders tend to decode the received signal, and if such an operation is not successful, a retransmission request is transmitted to the first transceiver using the transmission means 542 and the transmission antenna 544. Blocks that are unsuccessfully received are temporarily stored in a memory 546.

The first transceiver receives an acknowledgement with the antenna 520 and the receiving parts 518 and the control means 516 control the ST encoder to perform for at least some of the blocks a second space-time coding, and to carry out the retransmission. In a preferred embodiment, a different diversity method is employed in the transmission concerned than in the first transmission, but not necessarily a different space-time coding.

In the second transceiver, the channel decoders 536, 538 obtain retransmitted and received blocks from the equalizers and the previously received blocks from the memory 546. Space-time block decoding is performed for these blocks in the channel decoder using methods known for those skilled in the art.

The receiver maintains in the memory thereof the received signal and channel information, correlation matrixes or merely soft decisions (i.e. probability values of bits or symbols) of the previous transmissions and combines them with the values obtained from retransmissions. Storing only soft decisions in memory reduces the need for memory capacity. It should be noted that after retransmission the signal processing required is simpler than without retransmission. This is caused by the ortogonalization of the code. The number of receiver spaces is smaller with a combined code.

Let us still examine how the need for retransmission is defined. When the first transmission is received, error checking or calculation of reliability metrics is carried out and it is therefore noted whether the reception has been successful reliably enough. Retransmission is required, if for instance the signal-to-noise ratio, the reliability of received bits, decoding metrics or some other credibility measure indicates that the reception has not succeeded reliably enough. In addition, error correction/error detection, such as cyclic redundancy check CRC, can be used. In an alternative, the error detection is performed in such a manner that errors can be detected from a part of the frame or from some other part of the received signal. Then retransmission can be requested only for that particular part of the signal. The structure of the space-time code can be utilized when determining such parts. For instance, when using STTD-OTD coding, it is known that one half of the symbols is received with power a₁ and the other half with power a₂. Therefore, two CRC codes can be defined for these data flows. Consequently, the different parts in the space-time code may be provided with different error checking, coding and retransmission criteria.

Even though the invention has above been described with reference to the example according to the accompanying drawings, it is apparent that the invention is not restricted thereto but can be modified in many ways within the scope of the inventive idea presented in the appended claims.

1-30. (canceled)

31. A data transmission method between two transceivers, comprising:
using more than one radiation pattern for transmitting and receiving a signal in at least one of the transceivers;
dividing the symbols to be transmitted into blocks in the first transceiver;
encoding the blocks using a first space-time coding;
transmitting one block using a radiation pattern;
receiving the blocks in the second transceiver using one or more antennas;
checking whether retransmission is required in the second transceiver;
and if retransmission is required,
transmitting a retransmission message to the first to the first transceiver;
storing at least some of the blocks in a memory in the second transceiver;
encoding at least some of the same blocks using a second space-time coding;
retransmitting the encoded blocks from the first transceiver;
receiving the retransmitted blocks in the second transceiver using one or more antennas and performing a combined detection or decoding with the blocks in the memory.

32. A data transmission method between two transceivers), comprising:
using more than one antenna for receiving and transmitting a signal in at least one of the transceivers;
dividing the symbols to be transmitted into blocks in the first transceiver,
encoding the blocks using space-time coding;
transmitting one block from each antenna using a first diversity method;
receiving the blocks in the second transceiver using one or more antennas;
checking whether retransmission is required in the second transceiver;
and if retransmission is required,
transmitting a retransmission message to the first transceiver;
storing at least some of the blocks in a memory in the second transceiver;
encoding at least some of the same blocks using space-time coding;
retransmitting the encoded blocks from the first transceiver using a different diversity method than in the first transmission;
receiving the retransmitted blocks in the second transceiver using one or more antennas and performing a combined detection or decoding with the blocks in the memory.

33. A data transmission method between two transceivers, comprising:
using more than one radiation pattern for transmitting and receiving a signal in at least one of the transceivers;
dividing the symbols to be transmitted into blocks in the first transceiver;
encoding the blocks using a first space-time coding;
transmitting blocks using radiation patterns;
receiving the blocks in the second transceiver using one or more antennas;
checking whether retransmission is required in the second transceiver;
and if retransmission is required, transmitting a retransmission message to the first to the first transceiver;
storing at least some of the blocks in a memory in the second transceiver;
encoding at least some of the same blocks using a second space-time coding;
retransmitting the encoded blocks from the first transceiver;
receiving the retransmitted blocks in the second transceiver using one or more antennas and performing a combined detection or decoding with the blocks in the memory.

34. A data transmission method between two transceivers, comprising:
using more than one radiation pattern for transmitting and receiving a signal in at least one of the transceivers;
dividing the symbols to be transmitted into blocks in the first transceiver;
encoding the blocks using a first space-time coding;
performing at least one transmission of blocks using radiation patterns;
receiving the blocks in the second transceiver using one or more antennas;
checking whether retransmission is required in the second transceiver;
and if retransmission is required,
transmitting a retransmission message to the first to the first transceiver;
storing at least some of the blocks in a memory in the second transceiver;
encoding at least some of the same blocks using a second space-time coding;
retransmitting the encoded blocks from the first transceiver;
receiving the retransmitted blocks in the second transceiver using one or more antennas and performing a combined detection or decoding with the blocks in the memory.

35. A method as claimed in claim 31, wherein the space-time codings or diversity methods are selected so that the diversity degree of the combined signal exceeds the diversity degree in the first or second transmission alone.

36. A method as claimed in claim 31, wherein the space-time codings or diversity methods are selected so that the orthogonality of the combined signal exceeds the orthogonality in the first or second transmission alone.

37. A method as claimed in claim 31, wherein the first or second space-time coding is a non-orthogonal space-time code, and that the codes differ from one another.

38. A method as claimed in claim 37, wherein the second space-time code is a permutation from the first space-time code.

39. A method as claimed in claim 37, wherein the phasings of the codes deviate from one another.

40. A method as claimed in claim 37, wherein the first and the second code are transmitted through different radiation patterns.

41. A method as claimed in claim 37, wherein the information controlling the radiation pattern coefficients is calculated in the second transceiver and signalled to the first transceiver.

42. A method as claimed in claim 37, wherein the information controlling the radiation pattern coefficients is calculated in the first transceiver based on the information signalled in the second transceiver.

43. A method as claimed in claim 31, wherein the first and the second space-time codes are orthogonal, and that the symbols of the first and second space-time code represent different linear conversions of the symbols to be transmitted.

44. A method as claimed in claim 31, wherein the first and the second space-time codes are orthogonal, and that the first and the second space-time code symbols are provided with a different symbol alphabet.

45. A method as claimed in claim 31, wherein the first and the second space-time coding and transmission are carried out comprising:
receiving the blocks to be transmitted to the encoder of the transmitter;
performing space-time coding for the blocks to be transmitted in the encoder of the transmitter, whereby an MXM orthogonal space-time block encoded signal is obtained;
performing a phase-shift in the encoder of the transmitter for at least one of the M data flows, whereby at least one phase-shifted data flow corresponding to a non-phase-shifted data flow is obtained:
transmitting substantially simultaneously each of the M non-phase-shifted data flows and at least one phase-shifted data flow through different radiation patterns;
and that the second space-time coding and transmission use a different phase or radiation pattern order than the first coding and transmission.

46. A method as claimed in claim 31, wherein an effective correlation matrix is calculated for the combined blocks and detection or decoding is carried out by means of the correlation matrix.

47. A method as claimed in claim 31, wherein a soft or hard decision is calculated for the block symbols, and detection or decoding is carried out based on the combination of the separate decisions.

48. A method as claimed in claim 31, wherein the different space-time code parts are provided with a different quality checking, and the need for retransmission is checked separately for the different code parts.

49. A method as claimed in claim 31, wherein the reliability of the received signal is estimated and a decision on retransmission is made based on the estimated reliability.

50. A method as claimed in claim 31, wherein if retransmission is required, the second transceiver stores in a memory parameters associated with the blocks received at first.

51. A method as claimed in claim 31, wherein transmission comprises sending at least two symbols simultaneously using at least two different radiation patterns.

52. A data transmission system comprising a first and a second transceiver, the system further comprising:
in at least one of the transceivers more than one antenna for transmitting and receiving a signal;
and in which system the first transceiver is arranged to divide the symbols to be transmitted into blocks;
to encode the block using a first space-time coding,
and to transmit one block from each antenna;
and in which system the second transceiver is arranged to receive the blocks using one or more antennas;
wherein the second transceiver is arranged to check whether retransmission is required,
and if retransmission is required,
to transmit a retransmission request to the first transceiver; the second transceiver is arranged to store at least some of the blocks in a memory;
the first transceiver is arranged to encode at least some of the same blocks using a second space-time coding;
to retransmit the encoded blocks;
and the second transceiver is arranged to receive the retransmitted blocks in the second transceiver using one or more antennas and to combine them with the blocks in the memory.

53. A data transmission system comprising a first and a second transceiver, the system further comprising
in at least one of the transceivers more than one antenna for transmitting and receiving a signal;
and in which system the first transceiver is arranged
to divide the symbols to be transmitted into blocks;
to encode the block using a first space-time coding,
and to transmit one block from each antenna using a first diversity method;
and in which system the second transceiver is arranged to receive the blocks using one or more antennas;
wherein the second transceiver is arranged to check whether retransmission is required,
and if retransmission is required,
to transmit a retransmission request to the first transceiver;
the second transceiver is arranged to store at least some of the blocks in a memory;
the first transceiver is arranged to encode at least some of the same blocks using a second space-time coding;
to retransmit the encoded blocks using a different diversity method than in the first transmission;
and the second transceiver is arranged to receive the retransmitted blocks in the second transceiver using one or more antennas and to combine them with the blocks in the memory.

54. A system as claimed in claim 52, wherein the first and second space-time coding is a non-orthogonal space-time code, and that the codes deviate from one another.

55. A system as claimed in claim 52, wherein the space-time codings or diversity methods are selected so that the diversity degree of the combined signal exceeds the diversity degree in the first or second transmission alone.

56. A system as claimed in claim 52, wherein the space-time codings or diversity methods are selected so that the orthogonality of the combined signal symbols or the orthogonality of the bits exceed the orthogonality in the first or second transmission alone.

57. A system as claimed in claim 52, wherein the first transceiver comprises
means for space-time coding the blocks to be transmitted to an orthogonal M×M space-time block encoded signal,
means for phase-shifting at least one data flow from M data flows, whereby at least one phase-shifted data flow corresponding to a non-phase-shifted data flow is obtained,
means for transmitting substantially simultaneously each one of the M non-phase-shifted data flows and at least one phase-shifted data flow through different radiation patterns,
and that the first transceiver is arranged to use in the second space-time coding and transmission a different phase or radiation pattern order than in the first coding and transmission.

58. A system as claimed in claim 52, wherein the second transceiver is arranged to check the need for retransmission by estimating the reliability of the received signal.

59. A system as claimed in claim 52, wherein the second transceiver is arranged to check the need for retransmission separately for the different parts of the space-time code used in signal transmission.

60. A data transmission method between two transceivers comprising:
using more than one radiation pattern for transmitting and receiving a signal in at least one of the transceivers;
dividing the symbols to be transmitted into blocks in the first transceiver;
encoding the blocks prior to transmission using space-time coding comprising at least two parts;
transmitting one block part using a radiation pattern;
receiving the blocks in the second transceiver using one or more antennas;
selecting the space-time code so that the orthogonality or diversity degree of the combined signal exceeds that of the code parts separately and
transmitting the different parts of the space-time code using substantially the same antenna resources but different orthogonal channel resources.

61. A method as claimed in claim 60, wherein the orthogonal channel resources include time, frequency, sub-carrier, code and a combination thereof.

62. A method as claimed in claim 60, wherein the symbols in the different space-time code parts are unitary conversions of one another.

63. A method as claimed in claim 60, wherein the parts allocated into different channel resources are transmitted at least partly using different radiation patterns.

64. A transmitter, comprising:
means for using more than one radiation pattern for transmitting a signal;
means for dividing the symbols to be transmitted into blocks;
means for encoding the blocks using a first space-time coding;
means for transmitting blocks using radiation patterns;
means for receiving a retransmission message;
means for encoding at least some of the blocks using a second space-time coding if a retransmission message is received; and
means for retransmitting the encoded blocks if a retransmission message is received.

65. A transceiver, comprising:
one or more antennas or radiation patterns for receiving blocks encoded with a first space-time coding using;
means for checking whether retransmission is required;
and if retransmission is required, a memory means for storing at least some of the blocks;
means for transmitting a retransmission message;
one or more antennas for receiving retransmitted blocks encoded with a second space-time coding; and
means for performing a combined detection or decoding with the blocks in the memory.
